(19) United States
(12) Patent Application Publication
(10) Pub. No.: US 2009/0140504 A1
(43) Pub. Date: Jun. 4, 2009

(54) SHOPPING BAG WITH DETACHABLE WHEEL CHASSIS

(76) Inventor: Wai Lun Alan SUN, Lantau (HK)

Correspondence Address: RABIN & Berdo, PC, 1101 14TH STREET, NW, SUITE 500, WASHINGTON, DC, 20005, US

(21) Appl. No.: 12/055,394

(22) Filed: Mar. 26, 2008

(30) Foreign Application Priority Data
Nov. 30, 2007 (HK) 07113150.2

(51) Int. Cl. B62B 1/04

(52) U.S. Cl. 280/30

(57) ABSTRACT

The present invention relates to a shopping bag with a detachable wheel chassis. Said shopping bag comprises a bag body having bag handles and receiving portion on its bottom; and a wheel chassis connected with the shopping bag body in an inserting manner, which includes a pair of wheels and a shaft on two ends of which the wheels are respectively fitted by means of fixing elements and on which a supporting assembly including a supporting rod, two supporting members and a bracket is provided, and an inserting element is also provided wherein the inserting element can be inserted into the receiving portion of the bag body. Such a shopping bag has the advantages of simple structure producible in various sizes, ease of use, force saving and easily marketed.

### FIELD OF THE INVENTION

The present invention relates to a shopping bag, more specifically, to a force saving shopping bag with detachable wheels.

### BACKGROUND OF THE INVENTION

While attending large exhibitions and conventions or visiting shopping malls, customers need to carry goods including advertising documents and purchased items. By using a common hand-held shopping bag, once a large amount of goods have been accumulated, visitors and customers will feel tired, wanting to leave the venue early, thereby foregoing much potential business for merchants/exhibitors. Thus, there is a need for a shopping bag, which not only is convenient, and force saving, but also retain the original function of carry by hand. For this purpose, some shopping bags were designed to resolve the foregoing problems. For example, U.S. Pat. No. 6,293,569 has disclosed a mobile shopping bag that is distinct from the bag carriers. Although this kind of bag assembly can address the problem by means of wheel assembly mounted on the bottom of the bag and possess the effect of force saving, such a bag also has the following drawbacks: the wheels assembly may puncture though the bottom of the bag by which the integrity of the bag body will be compromised; platform is made of plastic material and requires injection molding tool each time a different shape is needed. For mass production, this can be a problem in terms of production time and costs. As these injection-molded platforms are not standardized; the mobile bag is not designed to allow the bag to stand stationary on the smooth floors; Usability wise, customer has to insert one wheel at a time, requiring too much time to create the assembly; it is high in production costs, using as many as 4 castor wheels. As a result, it may not be commercially feasible.

### BRIEF DESCRIPTION OF THE INVENTION

To address the aforesaid problems, an object of the present application is to provide a shopping bag with a detachable wheel chassis, which has the advantages of convenient use, lower cost and simple structure.

The object of the invention is achieved by such a shopping bag: it comprises a bag body having bag handles; and a wheel chassis connected with the shopping bag body in an inserting manner, which includes a pair of wheels and a shaft on two ends of which the wheels are respectively fitted by means of fixing elements and on which a supporting assemble including a supporting rod, two convex supporting members and a bracket is also provided; wherein said bag body is also provided with a receiving portion on its bottom and an inserting element detachably disposed in the receiving portion of the bag body.

The further improvement of the invention is that said receiving portion is an insertion slot which can receive the inserting element.

The further improvement of the invention is that said inserting element is disposed on the middle of shaft and can be abutted against the bracket connected respectively with two convex supporting members while the receiving portion suitable to the inserting element is mounted on the middle bottom of said bag body.

The further improvement of the invention is that on the bottom of the bag body, a holding block is also provided, which is able to be abutted against shaft.

The further improvement of the invention is that said receiving portion is also provided with a holding element.

The further improvement of the invention is that said holding element has a pair of hooks and loops fasteners by which the receiving portion can hold the wheel chassis in place securely.

The further improvement of the invention is that the hooks and loops fastener is a Velcro tape.

The further improvement of the invention is that wheels are fixed by means of nuts and matched screw threads on shaft.

The further improvement of the invention is that a plastic layer is wrapped on each of the supporting members.

The further improvement of the invention is that the plastic layer is PVC layer.

Compared with the prior art, the bag body and wheel chassis of the shopping bag of the present invention can be easily attached with an insertion method. The shopping bag may be a common hand-held shopping bag when the wheel chassis is detached from the insertion slot. The structure of the invention is very simple: only an inserting slot is provided on the middle bottom of the bag body and a suitable inserting element is provided on the wheel chassis; the bag can keep unmovable by using two wheels and two convex supporting members on floor, even on very smooth floors. The bag also has a holding block or a holding element to improve its stability, and the bag has the advantages of convenient use, force saving, lower cost and can be easily adopted.

### BRIEF DESCRIPTION OF THE DRAWINGS

Next, a further detailed description will be made as to the present invention with reference to the accompanying drawings.

FIG. 1 is a perspective view of the invention after inserting the wheel chassis;

FIG. 2 is a bottom view of the invention after inserting the wheel chassis;

FIG. 3 is a bottom view of the bag body of the invention;

FIG. 4 is a bottom view of the invention after inserting the wheel chassis, but unfolding the hooks and loops fastener;

FIG. 5 is a bottom view of the invention after inserting the wheel chassis and hooking the hooks and loops fastener;

FIG. 6 is a diagrammatic view of the wheel chassis of the invention;

FIG. 7 is a locally enlarged view of screw threads on the shaft of the wheel chassis;

FIG. 8 is a diagrammatic view of structure of inserting element and bracket;

FIG. 9 is a diagrammatic view of location relationship of inserting element and bracket;

FIG. 10 is a diagrammatic view of the supporting members of the invention; and

FIG. 11 is an enlarged view of a plastic layer wrapped on the supporting members of the invention.

### DESCRIPTION OF THE PREFERRED EMBODIMENT

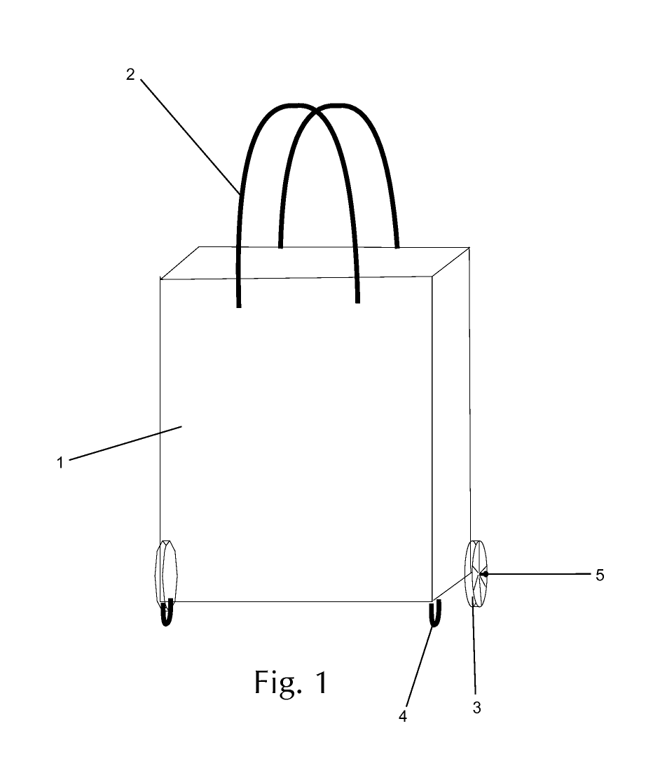

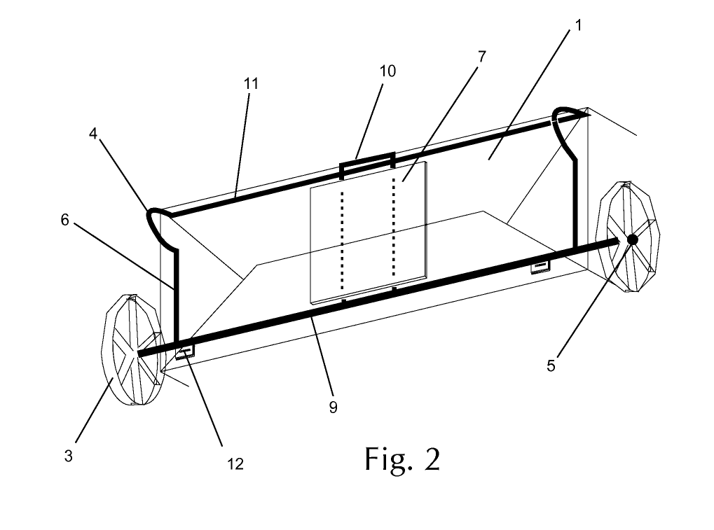

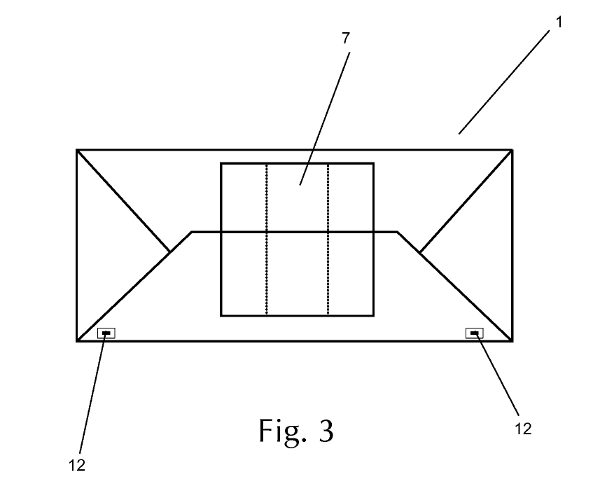

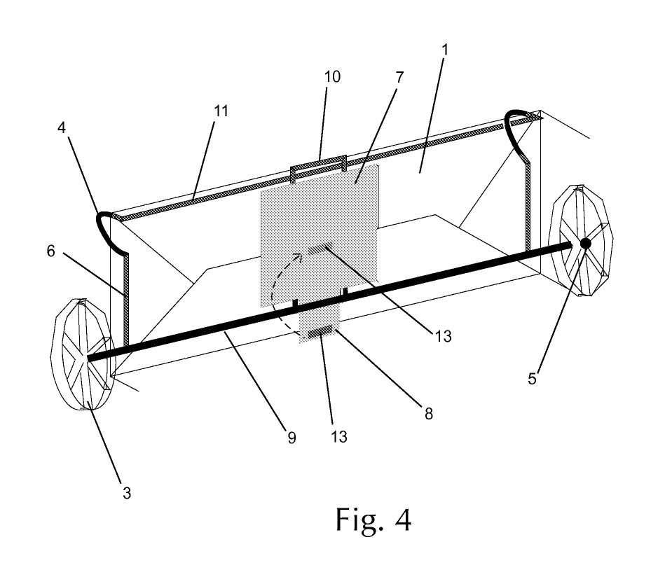

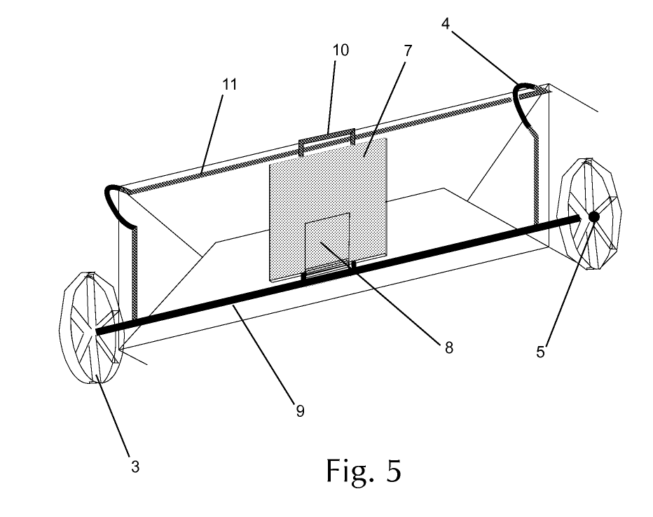

Referring to FIGS. 1-5, a shopping bag with a detachable wheel chassis of the invention comprises a bag body 1 having two handles 2, and the materials of which maybe paper, plastic or others, herein cardboard is preferred; and the materials of the handles 2 are the same as a common shopping bag which is usually used, but the length of the handles 2 can be longer than that of the common one so as to accommodate for convenient dragging of the shopping bag; a receiving portion 7 to be inserted is provided on the bottom of the bag body 1, which is formed as follows: firstly, a cardboard is chosen, then the left and right portion of it are fixed on the middle bottom of the bag body 1 by means of glue or others so as to form an insertion slot. Referring to FIGS. 2 and 3, the portion between the two dashed lines is not glued to the bottom of the bag body 1, which is called insertion slot; while the other two portions of the dashed lines shall be fixed on the bottom of bag body 1 by means of glue or others. However, the materials of the receiving portion 7 can be others in the invention, such as a plastic board, and other means to fix the inserting slot may also be adopted, such as staples, nails, etc.

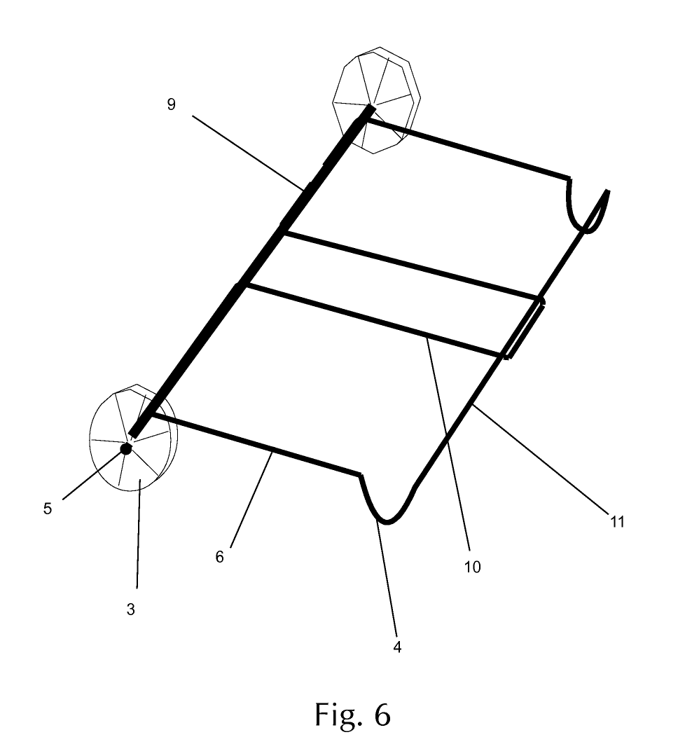

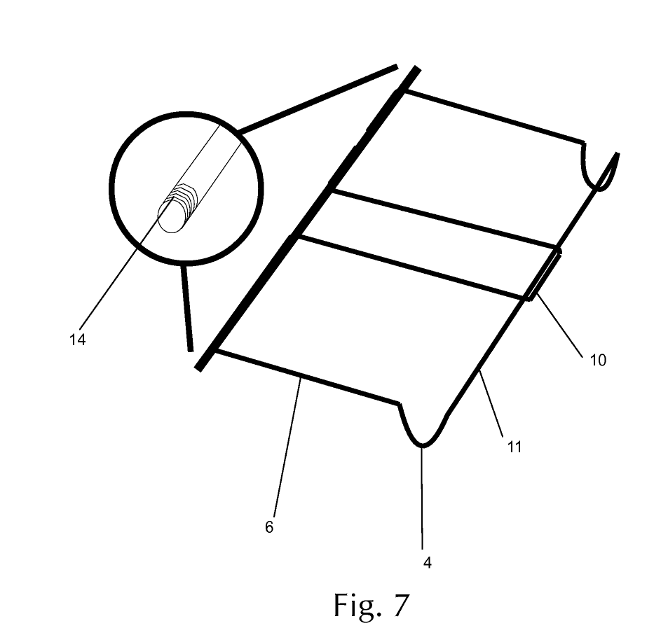

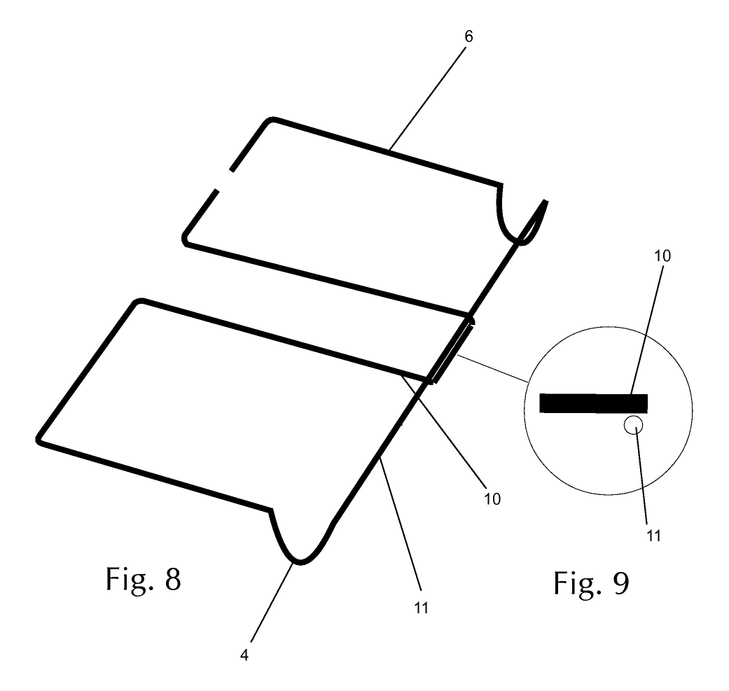

Referring to FIGS. 6 and 7, the present invention also includes a wheel chassis having a pair of wheels 3 and a shaft 9 on the two ends of which the wheel 3 are respectively fitted by means of fixing members and on which a supporting assembly including a supporting rod 6, two convex supporting members and a bracket 11 is provided. Referring to FIG. 7, screw threads 14 are preferred to be located on the two ends of the shaft 9, and after the wheels 3 are mounted on the shaft 9, two nuts 5 are screwed to fix the wheels 3. However, other fixing methods can be adopted to keep the wheels on the shaft. An inserting element 10 fixed on the shaft 9 can be inserted into the receiving portion and can also be detached from the receiving portion. In the embodiment, the inserting element 10 is fabricated to be a rectangle using metal or other materials and the inserting element 10 is welded on the middle of the shaft 9. Said inserting element 10 can be made other shapes, such as a triangle. The width of the inserting element 10 is substantially the same as that of the insertion slot so as to make the inserting element 10 insert into the insertion slot on the bottom of bag body 1. Meanwhile, the inserting element 10 can also support the bag body 1. Referring to FIGS. 8 and 9, a bracket 11 is mounted between the supporting members 4 and can be abutted against the inserting element 10, wherein the inserting element 10 is above the bracket 11. In the embodiment, the bracket 11 is a wire of common metal, and other materials can also be used. The inserting element 10 is not fixed on the bracket 11 and the bracket 11 can be abutted against the inserting element 10 so as to support the bag body 1 and the goods therein together with the inserting element 10.

When using the shopping bag, the inserting element 10 is inserted into the insertion slot on the middle bottom of the bag body 1, and the handles 2 can be dragged to go ahead. If necessary to stand the shopping bag on the floor, the two convex supporting members 4 and the two wheels 3 work to keep the bag unmovable, even on smooth surfaces.

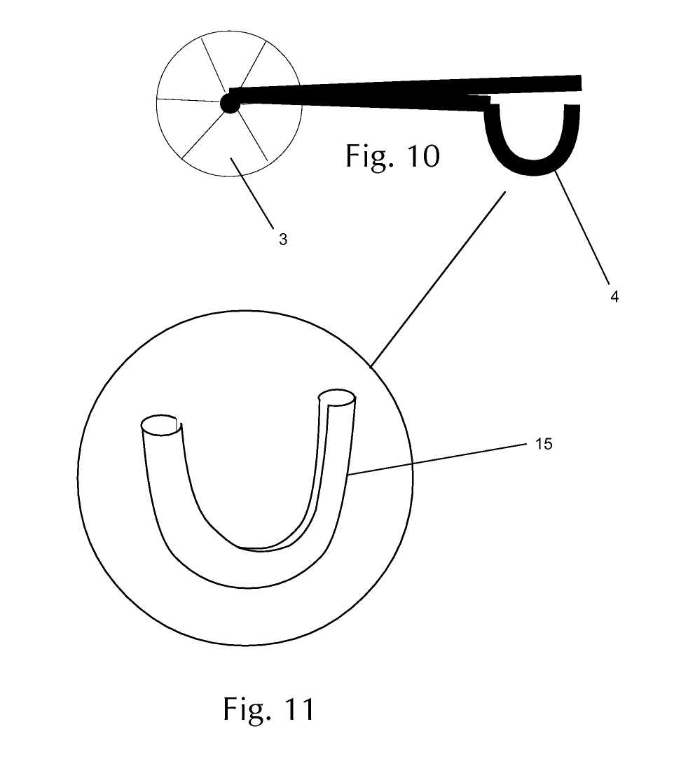

Referring to FIGS. 10 and 11, to avoid the supporting members 4 made of metal scratching the floor, a plastic layer 15 is wrapped on each of the supporting members 4. PVC layer is preferred in the embodiment.

Returning to FIGS. 2-5, when the shopping bag is stopped suddenly, the bag body 1 may be displaced a distance relative to the wheel chassis. Therefore, a holding element 8 is provided on the receiving portion 7 or a holding block 12 is provided on the bottom of the bag body 1 to avoid the relative displacement. In the embodiment, the holding element 8 is made by fixing a pair of hooks and loops fastener 13 on the cardboard and the corresponding portion of the receiving portion by means of glue, sewing or others, herein the hook and loop is a Velcro tape. After inserting the inserting element 10 into the inserting slot, the holding element 8 can be bent to fasten the Velcro tapes 13 well together, by which the receiving portion 7 can be held firmly on the wheel chassis. As additional support, the holding blocks 12 can be added. And the more numbers of the holding blocks 12 are placed, the better firmness of holding the chassis in place; in the embodiment, 2 or 3 holding blocks 12 are preferred. The holding blocks 12 are fixed on one edge of the bag body 1 using cardboard or other materials having a prefabricated thickness by means of glue, nails or others. When the inserting element 10 is inserted into the inserting slot, the holding blocks 12 can be abutted against the shaft 9 to stop the foward displacement of the bag caused by the sudden stop. Both the holding blocks 12 and the holding element 8 have the same functions in terms of keeping the bag body 1 and the wheel chassis firmly attached and eliminate relative displacement therebetween. The holding element 8 does perform better and cost lower than the holding blocks 12. Therefore, the producer may choose a suitable one to satisfy the market. The shopping bag can be detached from the wheel chassis when desired and a common shopping bag can also be provided.

In summary, the shopping bag of the present invention has the advantages of simple structure, lower cost, convenient use and force saving, which can be broadly used in all sorts of public areas such as a large exhibition convention, retail malls, super market and airports, etc.

What is claimed:

1. A shopping bag with a detachable wheel chassis comprises a bag body (1) having bag handles (2); and a wheel chassis connected with the shopping bag body (1) in an inserting manner, which includes a pair of wheels (3) and a shaft (9) on two ends of which the wheels (3) are respectively fitted by means of fixing elements and on which a supporting assembly including a supporting rod (6), two convex supporting members (4) and a bracket (11) is also provided; wherein said bag body (1) is also provided with a receiving portion (7) on its bottom and an inserting element (10) detachably disposed in the receiving portion (7) of the bag body (1).

2. The shopping bag according to claim 1, wherein said receiving portion (7) is an insertion slot which can receive the inserting element (10).

3. The shopping bag according to claim 1, wherein said inserting element (10) is disposed on the middle of shaft (9) and can be abutted against the bracket (11) connected respectively with two convex supporting members (4), while the receiving portion (7) suitable to the inserting element (10) is mounted on the middle bottom of said bag body (1).

4. The shopping bag according to claims 1, wherein on the bottom of the bag body (1), a holding block (12) is also provided, which is able to be abutted against shaft (9).

5. The shopping bag according to claims 2, wherein on the bottom of the bag body (1), a holding block (12) is also provided, which is able to be abutted against shaft (9).

6. The shopping bag according to claims 3, wherein on the bottom of the bag body (1), a holding block (12) is also provided, which is able to be abutted against shaft (9).

7. The shopping bag according to claim 1, wherein said receiving portion (7) is also provided with a holding element (8).

8. The shopping bag according to claim 2, wherein said receiving portion (7) is also provided with a holding element (8).

9. The shopping bag according to claim 3, wherein said receiving portion (7) is also provided with a holding element (8).

10. The shopping bag according to claim 7, wherein said holding element (8) has a pair of hooks and loops fasteners (13) by which the receiving portion (7) can hold the wheel chassis in place securely.

11. The shopping bag according to claim 10, wherein the hooks and loops fastener (13) is a Velcro tape.

12. The shopping bag according to claim 1, wherein wheels (3) are fixed by means of nuts (5) and matched screw threads (14) on shaft (9).

13. The shopping bag according to claim 1, wherein a plastic layer (15) is wrapped on each of the supporting members (4).

14. The shopping bag according to claim 3, wherein a plastic layer (15) is wrapped on each of the supporting members (4).

15. The shopping bag according to claim 9, wherein the plastic layer (15) is PVC layer.
